(19) United States
(12) Patent Application Publication
(10) Pub. No.: US 2023/0050927 A1
(43) Pub. Date: Feb. 16, 2023

(54) CONTACT ELEMENT ASSEMBLY FOR A PLUG CONNECTOR PART

(71) Applicant: Phoenix Contact E-Mobility GmbH, Schieder-Schwalenberg (DE)

(72) Inventors: Martin Wenz, Bad Pyrmont (DE); Eduard Fast, Blomberg (DE); Carsten Kuckuck, Hameln (DE); Hans-Guenther Langhardt, Luegde (DE)

(21) Appl. No.: 17/794,261

(22) PCT Filed: Jan. 21, 2021
(86) PCT No.: PCT/EP2021/051244

§ 371 Date: Jul. 21, 2022

(30) Foreign Application Priority Data
Feb. 14, 2020 (DE) 10 2020 103 866.6

(51) Int. Cl. H01R 4/18; H01R 4/60

(52) U.S. Cl. CPC H01R 4/183; H01R 4/188; H01R 4/60

(57) ABSTRACT

A contact element assembly for a plug connector part which is connectable in a plug-fitting manner to a mating plug connector part includes: a contact element which has a contact section for making electrical contact with a mating contact element, and a connecting section for producing a crimp connection with an electrical line connectable to the contact element. The connecting section is made of a copper alloy and has an opening for receiving the line and a circumferential surface delimiting the opening. The connecting section has a surface structure which is formed on the circumferential surface and operatively connects to the electrical line upon producing the crimp connection by reshaping the connecting section.

### CROSS-REFERENCE TO PRIOR APPLICATIONS

This application is a U.S. National Phase application under 35 U.S.C. § 371 of International Application No. PCT/EP2021/051244, filed on Jan. 21, 2021, and claims benefit to German Patent Application No. DE 10 2020 103 866.6, filed on Feb. 14, 2020. The International Application was published in German on Aug. 19, 2021 as WO/2021/160394 under PCT Article 21(2).

### FIELD

The invention relates to a contact element assembly for a plug connector part that can be connected in a plug-fitting manner to a mating plug connector part.

### BACKGROUND

Such a contact element assembly comprises a contact element which has a contact section for making electrical contact with a mating contact element, and a connecting section for producing a crimp connection with an electrical line to be connected to the contact element. The connecting section is produced from a copper alloy and has an opening for receiving the line, and a circumferential surface delimiting the opening.

Such a contact element assembly can be used on a plug connector part that can be plugged in a plug-fitting manner into an associated mating plug connector part. A plug connector part of the type being discussed here can, for example, be used as a charging plug or a charging socket for charging an electrically powered vehicle (also referred to as an electric vehicle). A charging socket is, for example, arranged on a vehicle and can be connected in a plug-fitting manner to an associated mating plug connector part, in the form of a charging plug on a cable connected to a charging station, in order to in this way establish an electrical connection between the charging station and the vehicle.

Given a plug connector part, for example of a charging system for charging an electric vehicle, one or more contact elements are connected to associated lines in order to conduct currents via the contact element for charging the electric vehicle during operation. The connection of a line to an associated contact element takes place via crimping, in that the line is placed on the connecting section of the respective associated contact element and the connecting section is plastically reshaped, so that the line is fastened positively and non-positively to the contact element.

The connection of the contact element to the associated line is hereby to be designed in such a way that an electrically favorable transition is established between the contact element and the line; that is to say, currents with a low contact resistance can be transmitted. In addition, the contact element should be connected to the line so as to be mechanically fixed and long-term stable, so that tensile forces acting between the contact element and the line do not lead to a release of the connection.

Given a plug connector known from DE 20 2018 104 958 U1, a contact element has a connecting section in the form of a connection region which can be reshaped in order to produce a crimp connection. The contact element can, for example, be produced from a copper-zinc alloy having a lead content of ≤0.1 percent by weight (wt %).

To produce contact elements, conventional materials are used which have a comparatively high lead content, for example a lead content greater than 1%. By using such lead-containing materials, especially a machinability of the material can be improved, resulting in a simple production. However, because lead is a heavy metal, there are regulations that limit the use of lead-containing materials for the manufacturing of products. There is therefore in principle the need to manufacture products from lead-free materials (i.e. materials with a lead content of ≤0.1 wt %).

A lines to be connected to a contact element can, for example, have a line core made of copper, which is to be connected to the contact element via a crimp connection for connection to the associated contact element. If the contact element is produced from a material different from the material of the line—namely a copper alloy—it can happen that the electromechanical connection produced by the crimp connection is possibly not reliable and stable in the long term, and in particular tensile forces between the contact element and the line are not able to be absorbed with sufficient stability. This is due to the fact that the copper material of the line core and the material of the contact element behave differently during crimping with regard to a rebound.

Given use of different materials for the line and the contact element, there is therefore a need to create a possibility for producing the crimp connection between the contact element and the line in such a way that the crimp connection creates a reliable and long-term stable connection between the line and the contact element.

Given a heavy-duty plug connector known from DE 10 2014 112 701 A1, a crimp contact is arranged on an insulating body, said crimp contact being of rotationally symmetrical design at least in regions, and having in a crimp region a cylindrical cavity with a cable insertion opening for receiving a stranded aluminum core. In the cylindrical cavity, the crimp contact has an internal thread.

DE 7045 534 U discloses a compression cable lug in which a thread is formed on an inner surface of a cable lug sleeve.

### SUMMARY

In an embodiment, the present invention provides a contact element assembly for a plug connector part which is connectable in a plug-fitting manner to a mating plug connector part, comprising: a contact element which has a contact section configured to make electrical contact with a mating contact element, and a connecting section configured to produce a crimp connection with an electrical line connectable to the contact element, wherein the connecting section comprises a copper alloy and has an opening configured to receive the line and a circumferential surface delimiting the opening, and wherein the connecting section has a surface structure which is formed on the circumferential surface and is configured to operatively connect to the electrical line upon producing the crimp connection by reshaping the connecting section.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic representation of an electric vehicle with a charging cable and a charging station for charging;

FIG. 2 is a view of a plug connector part in the form of an inlet on the side of a vehicle;

FIG. 3 is a view of a contact element for connecting to a mating contact element;

FIG. 4A is a view of an exemplary embodiment of a contact element;

FIG. 4B is an end view of a connecting section of the contact element;

FIG. 4C is a view of the contact element, in the area of the connecting section, sectioned along the line B-B according to FIG. 4B;

FIG. 5 is a partial sectional view of another exemplary embodiment of a contact element;

FIG. 6 is a partial sectional view of yet another exemplary embodiment of a contact element;

FIG. 7A is a sectional view of an exemplary embodiment of a contact element;

FIG. 7B is a view of the contact element, enlarged in part, illustrating a groove within an opening of the connecting section;

FIGS. 8A-F are views of different forms of a groove in an opening of the connecting section of the contact element; and

FIG. 9 is a view of an electrical line to be connected to a contact element.

### DETAILED DESCRIPTION

In an embodiment, the present invention provides a contact element assembly for a plug connector part which enables a reliable crimp connection with a line given an at least partial production of the contact element from a copper alloy, even if the line is manufactured from a different material than the contact element.

Accordingly, the connecting section has a surface structure which is formed on the circumferential surface and designed to come into an operative connection with the electrical line during the production of the crimp connection by the reshaping of the connecting section.

The opening in the connecting section into which the line for connecting to the contact element is inserted is, for example, of cylindrical shape. The opening can, for example, be arranged as a blind hole in the connecting section, so that a line can be inserted into the opening along an insertion direction. If the line has been inserted into the opening, the connecting section can be reshaped using a suitable crimping tool, in particular crimping pliers, in order to in this way create a crimp connection between the contact element and the line, and thus to firmly and inseparably (permanently) connect the contact element to the line.

If the opening is cylindrically shaped, the circumferential surface surrounds the opening in a rotationally symmetrical manner, corresponding to the (circular) cylindrical shape of the opening, and is thus formed by an inner shell surface delimiting the opening. The surface structure formed on the circumferential surface interrupts the planar extension of the circumferential surface, in that the surface structure is formed as an elevation or depression on the circumferential face, and thus structures are created on the circumferential surface which point radially inward or radially outward with respect to the circumferential surface. In the production of the crimp connection, a positive connection is created between the connecting section of the contact element and the line, in particular between the surface structure on the circumferential surface inside the opening of the connecting section and a line core section of the line received in the opening, so that the strength of the connection between the contact element of the line is improved. By producing a claw connection of the surface structure with the line, a tensile strength can especially be increased so that tensile forces acting between the contact element and the line can be absorbed and dissipated, and do not lead to a release of the connection between the contact element and the line.

By forming a surface structure in or on the circumferential surface, it can especially be achieved that a contact surface pressure between strands of a line core of a line and the connecting section of the contact element is improved, and moreover a non-positive and positive contact pairing is created.

The surface structure can, for example, have at least one groove formed in the circumferential surface. An arrangement of one or more grooves is thus formed in the circumferential surface within the opening of the connecting section so that, upon reshaping of the connecting section to create the crimp connection, the circumferential surface with the surface structure formed thereon can engage in a claw-like manner with the line in order to in this way produce a non-positive and positive connection between the contact element and the line.

In cross-section (transverse to its extension direction), the groove can, for example, be round (for example arcuate, in particular semicircular), triangular, trapezoidal, or rectangular.

An edge which can be sharp-edged or, alternatively, rounded can be formed at a transition of the groove to the circumferential surface. If the edge is rounded, the edge, in cross-section transverse to the direction of longitudinal extent of the groove, can have a rounding defined by a radius, for example. By means of such a rounding, it can especially be achieved that, given a connection between the connecting section and the line, damage to strands of a line core of the line is prevented in that the surface structure on the circumferential surface within the opening of the connecting section does not act on the line with a sharp edge.

In one embodiment, the at least one groove runs around the opening. In particular, the groove can, for example, extend circumferentially around an insertion direction within the opening on the circumferential surface, along which insertion direction a line can be inserted into the opening. The groove can hereby run helically around the opening to form a thread. Alternatively, the groove can be closed in a ring shape, wherein a plurality of grooves axially offset from one another can be formed within the opening.

Additionally or alternatively, one or more grooves can also extend axially within the opening, thus along the insertion direction in which a line is to be inserted into the opening, in order to connect the line to the connecting section of the contact element.

If the groove forms a thread within the opening, the thread can be a single- or even multiple-thread. A multiple-thread is hereby understood to mean a thread in which a plurality of thread turns run parallel to one another. For example, such a multiple-thread can have two thread turns.

In one embodiment, the at least one groove has a depth between 0.02 mm and 0.4 mm. The depth is hereby measured between an inner radius of the circumferential surface and the radially lowest point of the groove, which is formed radially outward in the circumferential surface. Due to the fact that the groove has a comparatively shallow depth, the planar extension of the circumferential surface can be interrupted, wherein sharp-edged and deep structures on the circumferential surface are avoided in order to in this way reduce the risk of damage to the line in producing the crimp connection.

In one embodiment, the copper alloy from which at least the connecting section of the contact element is produced, but advantageously the entire contact element, has a lead content of ≤0.1 percent by weight. The contact element is thus produced from a material which has negligibly small lead additives, so that legal requirements for lead-free products can be met.

The copper alloy can be a copper-zinc government with a zinc content of, for example, ≥30 percent by weight, for example ≥40 percent by weight, for example CuZn40 or CuZn42. Due to the high zinc content of the alloy, the workability can be improved with respect to deformability and machinability, without lead additives in the alloy being required. This enables simple, advantageous manufacturing of the contact element and reliable production of the crimp connection for connecting the line to the contact element.

In one embodiment, an electrical line to be connected to the contact element has an electrically conductive line core which is produced from a material, for example copper, that is different from the copper alloy of the connecting section of the contact element. Due to elastic material properties, this can hereby result in a different reshaping behavior at the connecting section and at the line upon creating the crimp connection. In general, a plastic deformation on the connecting section is effected upon reshaping the connecting section in order to create the crimp connection. The connecting section is hereby reshaped in a pressing manner so that a press connection is made between the connecting section and the line. Upon pressing, a different spring behavior can hereby occur on the connecting section than on the line. For example, if the connecting section flexes by a greater distance than the line, the quality of the crimp connection can hereby be impaired.

This is due to the fact that, upon crimping, the inner width of the opening of the connecting section is reduced by reshaping on the connecting section, and the connecting section is thus pressed with the line. If, due to a rebound of the connecting section, the opening widens again by a certain distance after the crimping connection has been produced, without the line widening in the same way, the surface pressure between the connecting section and the line will be reduced due to this rebound behavior.

This is counteracted by the surface structure created on the inner circumferential surface of the opening. By providing the surface structure on the circumferential surface, an improved positive fit and an increased contact surface pressure occur upon crimping so that, even given a material pairing with a disadvantageous rebound behavior, the electromechanical crimp connection can be produced securely and reliably and a sufficient tensile strength is ensured.

The elastic properties of the material of the line core (for example copper) and of the copper alloy of the connecting section can respectively be described by the E modulus and the yield strength. The E modulus is the modulus of elasticity, which indicates the slope in the stress-strain diagram given elastic deformation in the linear range. The modulus of elasticity is usually given in GPa (gigapascals) or MPA (megapascals). The yield strength is understood here to mean what is known as the 0.2% yield strength or elastic limit Rp 0.2, which can be read off the stress-strain diagram and indicates the mechanical stress at which the plastic (remaining) elongation is 0.2% after release, based on the initial length of a sample of a material.

A contact element with a connecting section produced from a copper alloy and a surface structure of the described type formed on a circumferential surface can be especially advantageously used if

(a) the modulus of elasticity of the material of the line core is greater than the modulus of elasticity of the copper alloy of the connecting section, and in addition the yield strength of the material of the line core is less than the yield strength of the copper alloy of the connecting section, or

(b) the modulus of elasticity of the line core is less than the modulus of elasticity of the copper alloy of the connecting section, and in addition the yield strength of the material of the conduit is less than the yield strength of the copper alloy of the connecting section, or

(c) the modulus of elasticity of the material of the line core is greater than the modulus of elasticity of the copper alloy of the connecting section, and moreover the yield strength of the material of the line core is greater than the yield strength of the copper alloy of the connecting section.

These relationships between the modulus of elasticity and the yield point generally result in a rebound behavior given which, after the crimping, the connecting section rebounds in the direction of a widening of the opening by a greater distance than does the line. In these relationships between the modulus of elasticity and the yield strength, an improvement of the connection between the line and the contact element can thus be created by creating a surface structure on the inner circumferential surface of the connecting section. In particular, an inhomogeneous elastic recovery at the connecting section and the line can be used to ensure remaining residual stresses in the axial direction of the connecting section so that a tension-resistant connection between the connecting section and the line can be created.

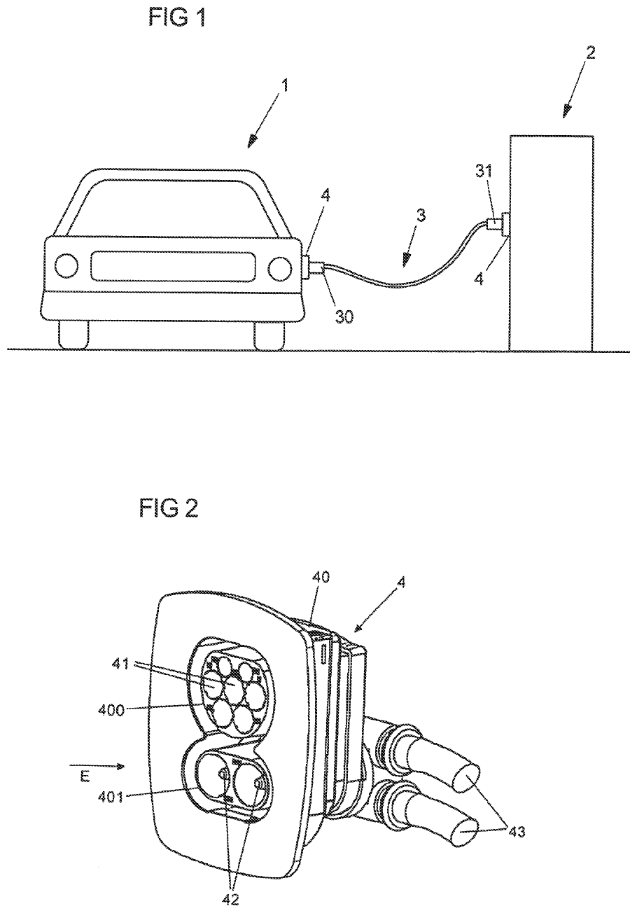

FIG. 1 shows in a schematic view a vehicle 1 in the form of a vehicle powered by an electric motor (also referred to as an electric vehicle). The electric vehicle 1 has electrically chargeable batteries via which an electric motor for moving the vehicle 1 can be electrically supplied.

In order to charge the batteries of the vehicle 1, the vehicle 1 can be connected to a charging station 2 via a charging cable 3. For this purpose, the charging cable 3 can be plugged with a charging plug 30 at one end into an associated mating connector part 4 in the form of a charging socket of vehicle 1 and is electrically connected at its other end via another charging plug 31 to a connector part 4 in the form of a charging socket on charging station 2. Charging currents of a comparatively high current intensity are transmitted to the vehicle 1 via the charging cable 3.

The connector part 4 on the side of the vehicle 1 and the connector part 4 on the side of the charging station 2 can differ. It is also possible to arrange the charging cable 3 undetachably at the charging station 2 (without plug connector part 4).

FIG. 2 shows an exemplary embodiment of a connector part 4 in the form of a charging socket, for example, on the side of a vehicle (also referred to as a vehicle inlet), which can be connected, in a plug-in manner, to an associated mating connector part 30 in the form of a charging plug on a charging cable 3 so as to connect the electric vehicle 1 to the charging station 2 of the charging system. The connector part 4 comprises a housing part 40 on which plug-in sections 400, 401 are formed, to which the connector part 30 can be connected, in a plug-in manner, along a plug-in direction E. At the plug-in sections 400, 401, plug-in openings are formed in which contact elements 41, 42 are arranged via which an electrical connection to the associated mating connector part 30 can be established given a plug-in connection.

In the exemplary embodiment shown, on a first, upper plug-in section 400, contact elements 41 are arranged via which, for example, a charging current in the form of an alternating current can be transmitted. In addition, contact elements may be present via which control signals can be transmitted.

In contrast, two contact elements 42, via which a charging current in the form of a direct current can be transmitted, are arranged on a second, lower plug-in section 401. The contact elements 42 are connected to load lines 43 via which the charging current is conducted.

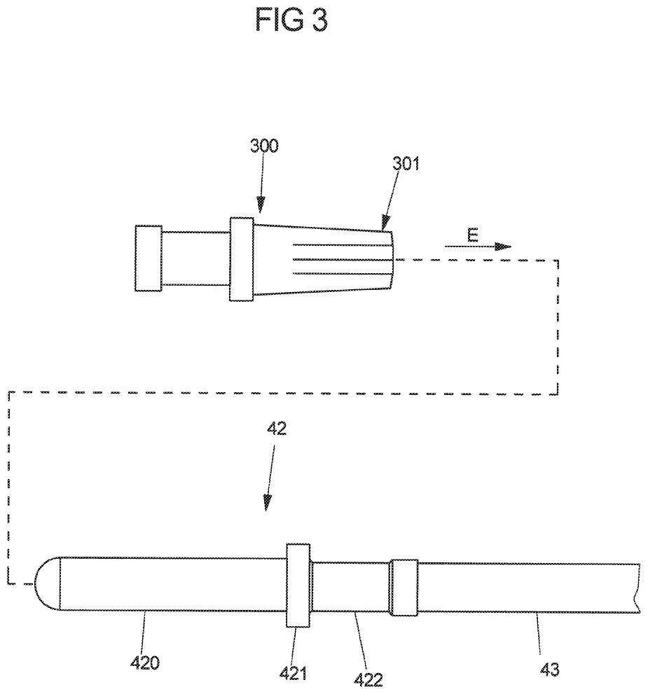

FIG. 3 shows an exemplary embodiment of a contact element 42 which can, for example, be used at the plug-in section 401 (below in FIG. 2) for transmitting a charging current in the form of a direct current. A contact element 41 at the plug-in section 400 for transmitting an alternating current can be of structurally identical design.

The contact element 42 of the exemplary embodiment according to FIG. 3 has a contact section 420 in the form of a contact pin which can be connected in a plug-fitting manner to a mating contact element 300 of a mating plug connector part 30. The mating contact element 300 has a contact section 301 in the form of a contact socket, into which the contact element 42 with the contact section 420 can be inserted along the plugging direction E.

The contact element 42 has a collar 421 projecting radially in relation to the contact section 420, and a connecting section 422 adjoining the collar 421. An associated line 43, via which load currents are transmitted during operation, can be connected to the contact element 42 via the connecting section 422, wherein the connecting section 422 is designed to produce a crimp connection and can thus be reshaped in order to connect the line 43.

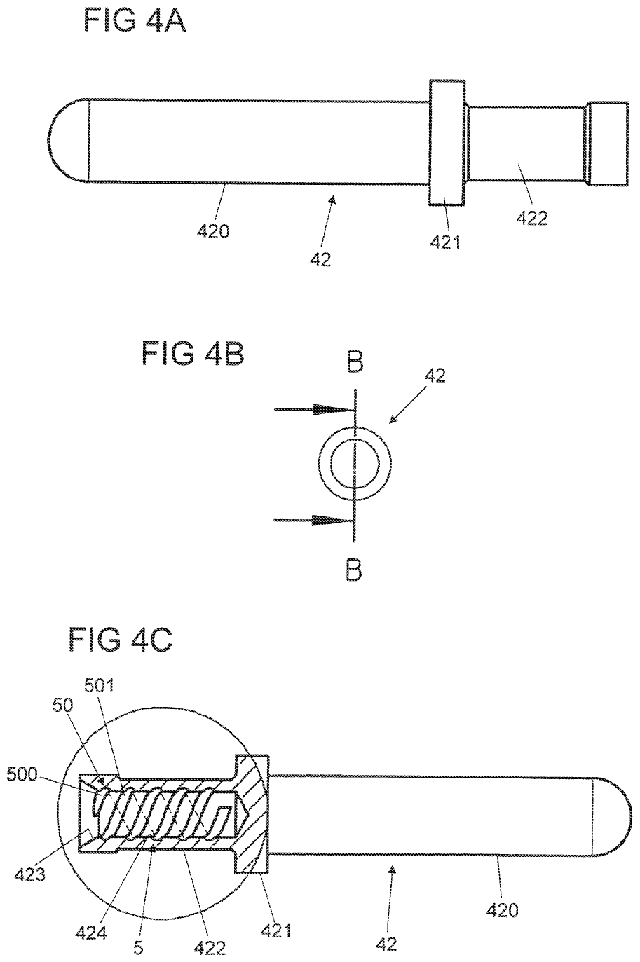

In an exemplary embodiment of a contact element 42, illustrated in FIG. 4A to 4C, an opening 423 in the form of a blind hole is formed in the connecting section 422, into which blind hole the associated line 43 can be inserted along an insertion direction in order to, given an inserted line 43, produce a crimp connection between the connecting section 422 and the line 43 by a reshaping on the connecting section 422. The opening 423 can, for example, be formed in a machining manner by drilling at the connecting section 422, and extends axially into the connecting section 422 from an end of the connecting section 422 which is remote from the contact section 420.

In the shown exemplary embodiment, the connecting section 422 has a cylindrical basic shape and is rotationally symmetrical in form (at least in an initial state before the connecting section 422 is reshaped). The opening 423 is likewise cylindrically shaped in its significant extension region, and is circumferentially delimited by a cylindrical circumferential surface 424.

By reshaping at the connecting section 422, a crimp connection can be created between the connecting section 422 and a line 43 inserted into the opening 423. As can be seen from FIG. 9, the line 43 can have a line core 430 with strands 431 which are guided within a cable jacket 432. For connecting to the connecting section 422, the line 43 is inserted into the opening 422 with a stripped conductor end, thus exposed strands 431, so that an electromechanical connection to the contact element 42 can be achieved by crimping.

In the shown exemplary embodiment, the contact element is manufactured as one piece from a copper alloy, for example CuZn40 or CuZn42. In contrast, the strands 431 of the line core 430 of the line 43 can be produced from copper, for example. This results in a material pairing in which the connecting section 422 and the line 43 can have a different deformation behavior.

Given a reshaping at the connecting section 422 in order to create the crimp connection, the clear width of the opening 423 is reduced, and in this way the line 43 inserted into the opening 423 is pressed with the connecting section 422. After the crimping connection has been created by pressing, a rebound can hereby occur both at the connecting section 422 and at the line section of the line 43 lying within the opening 423, wherein it may especially occur that the connecting section 422 rebounds a greater distance in the direction of a widening of the opening 423 than the line 43. This can cause a surface pressure between the connecting section 422 and the line 43 to be reduced after production of the crimp connection, which in particular can impair the tensile strength of the connection and also the electrical quality of the connection.

For this reason, in the exemplary embodiment according to FIG. 4A to 4C, a surface structure 5 is formed on the inner circumferential surface 424 of the opening 423, which surface structure forms two grooves 50 formed radially in the circumferential surface 424. The grooves 50 interrupt the otherwise rotationally symmetrical, planar extension of the circumferential surface 424 and run circumferentially within the opening 423.

In the shown exemplary embodiment, the grooves 50 jointly form two turns 500, 501 of a double-thread.

By providing the surface structure 5 in the form of the grooves 50 within the opening 423, an especially form-fitting connection can be achieved between the connecting section 422 and the line 43 upon pressing the connecting section 422 with the line 43 to produce the crimp connection. Even given a disadvantageous rebound behavior, a sufficient axial tensile strength in the connection, and thus a reliable, long term-stable electromechanical connection, can be ensured.

In the exemplary embodiment according to FIG. 4A to 4C, the surface structure 5 is created by circumferential grooves 50 running helically within the opening 423, which together form a double-thread. In contrast, in an exemplary embodiment shown in FIG. 5, grooves 50 are formed within the opening 423, which grooves 50 run annularly within the opening 423 and thus extend in a circumferentially closed manner around an insertion direction along which a line can be inserted into the opening 423. A plurality of grooves 50 are hereby axially offset from one another within the opening 423.

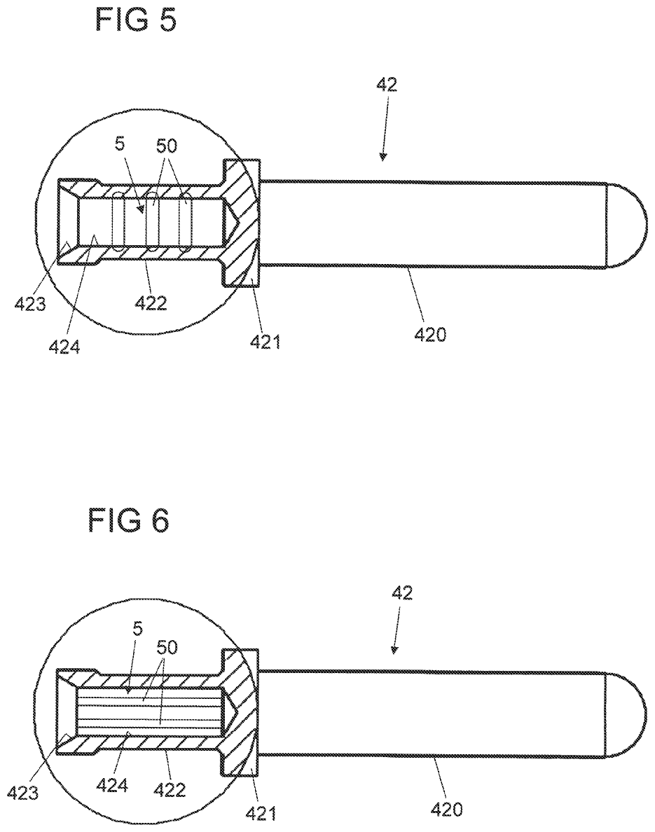

In an exemplary embodiment shown in FIG. 6, in comparison with the exemplary embodiment according to FIG. 5, within the opening 423 grooves 50 are formed which extend axially along an insertion direction along which a line can be inserted into the opening 423. A plurality of grooves 50 are formed that are circumferentially distributed within the opening 423.

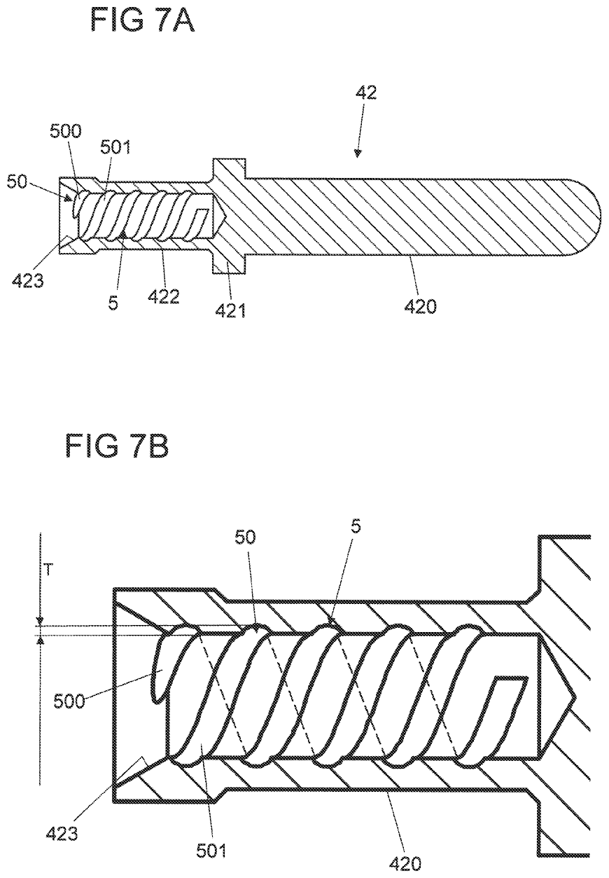

The grooves 50 of the exemplary embodiments according to FIG. 4A to 4C, 5, and 6 are adapted in terms of their shape, in particular their cross-sectional shape and depth, such that an advantageous, loadable, positive connection between the connecting section 422 and a line 43 can be achieved upon producing a crimp connection. As illustrated in FIG. 7A, 7B, the grooves 50 can hereby have a depth T which, for example, lies within a range between 0.02 mm and 0.4 mm, so that the grooves 50 have a comparatively shallow depth T compared to a conventional thread. The depth T is hereby measured between the radially inner circumferential surface 424 and the radially outermost point of each groove 50.

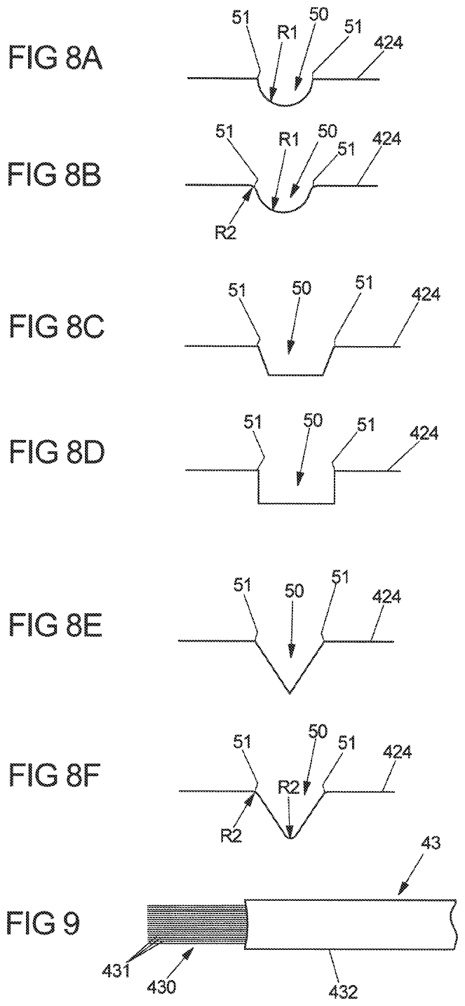

As illustrated in FIG. 8A to 8F, the grooves 50 may be shaped differently in cross-section. Different cross-sectional shapes in the cross-section transverse to the direction of longitudinal extent of a single groove 50 are hereby shown in FIG. 8A to 8F.

As shown in FIG. 8A, in cross-section the groove 50 can, for example, be round, for example arcuate, in particular semi-circular. The rounding of the groove 50 can hereby be described by a radius R1, wherein the groove 50 is delimited on both sides by edges 51 which represent a transition to the adjoining circumferential surface 424 and are designed to be sharp-edged in the exemplary embodiment according to FIG. 8A. The edges 51 extend along both sides along the groove 50.

In the exemplary embodiment according to FIG. 8B, the groove 50 is round, wherein the edges 51 are rounded. The rounding at the edges 51 can hereby be described by a radius R2, which can in particular be smaller than the radius R1 of the groove 50.

Given an exemplary embodiment illustrated in FIG. 8C, the groove 50 is trapezoidal in cross-section. Lateral flanks of the groove 50 are thus positioned obliquely. Edges 51 can be sharp-edged or rounded (as in FIG. 8B).

In an exemplary embodiment shown in FIG. 8D, the groove 50 is rectangular in cross-section. Edges 51 can in turn be sharp-edged or rounded (as in FIG. 8B).

In an exemplary embodiment shown in FIG. 8E, the groove 50 is triangular. Edges 51 can be sharp-edged or, as illustrated in FIG. 8F, rounded, wherein an edge at the bottom of the groove 50 can also be rounded.

The idea behind the invention is not limited to the exemplary embodiments described above but can also be implemented in another manner.

By providing a surface structure within a connecting section of a contact element produced from a copper alloy, a good electromechanical connection between the connecting section and the line can be achieved by producing a crimp connection, even given a disadvantageous material pairing. Such a surface structure can be formed in any way desired and interrupts an otherwise especially rotationally symmetrical shape of a circumferential surface within an opening for receiving the line.

A surface structure can especially be formed by a groove or else a web, wherein other structures, in particular in the manner of nubs, pins, or recesses, pockets or the like, can also form the surface structure.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Vehicle
2 Charging station
3 Charging cable
30, 31 Mating plug connector part (charging plug)
300 Mating contact element
301 Contact section (contact socket)
4 Plug connector part
40 Housing part
400, 401 Plug-in section
41 Contact element
42 Contact element
420 Contact section (contact pin)
421 Collar
422 Connecting section
423 Opening
424 Inner shell surface
43 Electrical line (load line)
430 Line core
431 Strands
432 Cable sheath
5 Surface structure
50 Groove arrangement
500, 501 Thread
51 Edge
E Insertion direction
R1, R2 Radius
T Depth

1. A contact element assembly for a plug connector part which is connectable in a plug-fitting manner to a mating plug connector part, comprising:
a contact element which has a contact section configured to make electrical contact with a mating contact element, and a connecting section configured to produce a crimp connection with an electrical line connectable to the contact element,
wherein the connecting section comprises a copper alloy and has an opening configured to receive the line and a circumferential surface delimiting the opening, and
wherein the connecting section has a surface structure which is formed on the circumferential surface and is configured to operatively connect to the electrical line upon producing the crimp connection by reshaping the connecting section.

2. The contact element assembly of claim 1, wherein the opening is cylindrically shaped at least in sections.

3. The contact element assembly of claim 1, wherein the circumferential surface extends circumferentially around the opening.

4. The contact element assembly of claim 1, wherein the surface structure interrupts the circumferential surface.

5. The contact element assembly of claim 1, wherein the surface structure has at least one groove formed on the circumferential surface.

6. The contact element assembly according to claim 5, wherein the at least one groove is, in cross-section, round, triangular, trapezoidal, or rectangular.

7. The contact element assembly of claim 5, further comprising:
an edge extending longitudinally along the at least one groove, delimiting the at least one groove, forming a transition to the circumferential surface,
wherein the edge has a rounding defined by a radius.

8. The contact element assembly of claim 5, wherein the at least one groove runs around the opening.

9. The contact element assembly of claim 5, wherein the at least one groove extends axially along the opening.

10. The contact element assembly of claim 5, wherein the at least one groove forms a thread running around the circumferential surface.

11. The contact element assembly of claim 5, wherein the at least one groove comprises at least two grooves, the at least two grooves forming a thread with at least two turns.

12. The contact element assembly of claim 5, wherein the at least one groove has a depth between 0.02 mm and 0.4 mm,

13. The contact element assembly of claim 1, wherein the copper alloy has a lead content of ≤0.1 wt %.

14. The contact element assembly of claim 1, wherein the copper alloy has a zinc content Zn of ≥30 wt %.

15. The contact element assembly of claim 1, further comprising:
an electrical line, having an electrically conductive line core, connectable to the contact element.

16. The contact element assembly of claim 15, wherein the line core comprises copper.

17. The contact element assembly of claim 15, wherein a material of the line core has a first modulus of elasticity and a first yield strength, and the copper alloy of the connecting section has a second modulus of elasticity and a second yield point, and
wherein (a) the first modulus of elasticity is greater than the second modulus of elasticity and the first yield strength is less than the second yield strength, or (b) the first modulus of elasticity is less than the second modulus of elasticity and the first yield strength is less than the second yield strength, or (c) the first modulus of elasticity is greater than the second modulus of elasticity and the first yield strength is greater than the second yield strength.
